(19) United States
(12) Patent Application Publication
(10) Pub. No.: US 2011/0232187 A1
(43) Pub. Date: Sep. 29, 2011

(54) Nursery container

(76) Inventors: Theresa Z. Quan, City of Industry, CA (US); James H. Wu, City of Industry, CA (US); Xin Wang, City of Industry, CA (US)

(21) Appl. No.: 12/661,888

(22) Filed: Mar. 24, 2010

(51) Int. Cl. A01G 9/02

(52) U.S. Cl. 47/84

(57) ABSTRACT

A nursery container includes a container body and a grip-and-hold arrangement. The container body has at least one sidewall having a top edge portion and defining a nursery compartment within the container body, and a bottom panel. The grip-and-hold arrangement is formed at the top edge portion of the sidewall of the container body, and comprises a reinforcing rim integrally and outwardly extended from the top edge portion of the sidewall, wherein the reinforcing rim has a curved sectional shape formed along an entire length of the reinforcing rim so as to evenly distribute externally applied force along the reinforcing rim without substantial stress concentration, wherein a user is allowed to effectively grip on the reinforcing rim to carry an entire structure of the nursery container without significant risk of breakage at the reinforcing rim.

### BACKGROUND OF THE PRESENT INVENTION

1. Field of Invention

The present invention relates to a container, and more particularly to a nursery container comprising a grip-and-hold arrangement which is capable of minimizing stress concentration at a reinforcing rim thereof so as to allow easy moving of the nursery container without significant risk of breakage at the reinforcing rim.

2. Description of Related Arts

Referring to FIG. 1 of the drawings, a conventional nursery container usually comprises a cylindrical container body 10P. The container body 10P usually has a circular or substantially circular sidewall 11P, a bottom panel 12P formed at a bottom edge portion of the sidewall 11P, and a receiving cavity 13P formed within the boundary enclosed by the circular sidewall 11P for allowing a user to put soil in the receiving cavity 13P for planting specific plants.

Very often, the container body 10P further has a top rim portion 14P outwardly and radially extended from the top edge portion of the sidewall 11P, wherein the top rim portion 14P has a substantially U-shape cross section defining an acute angle (which is approximately 90°) between the substantially vertically extending sidewall 11P and the outwardly and radially extending top rim portion 14P. This top rime portion 14P is conventionally designed for allowing a user to grip on a bottom portion of the top rim portion so that he or she can move the container from one place to another.

As to the material involved, the conventional nursery container described above is usually made by plastic material. This has several advantages. First, plastic-made conventional nursery container is convenient for mass production. Moreover, plastic is a relatively light material which can be transported easily and economically. Furthermore, a plastic-made nursery container does not break as easily as glass-made containers or porcelain-made containers.

Despite these advantages, there exist a number of disadvantages for this type of conventional nursery container. First, the nursery container is usually required to contain soils and plants having great mass. On the other hand, the nursery container may need to be moved frequently in the user's garden because of changing weather or other conditions. As a result, when the user wishes to move a particular plant from one place to another in his or her garden, he or she will grab on a single point of the top rim portion 14P of the nursery container and pull the container from its original position to a desirable position. From simple material science theory, however, when a force is applied to an object having corners of acute angle, stress will concentrates at those corners and makes those positions break very easily. When this theory applies to the conventional nursery container scenario, stress will concentrate at the acute angle formed by the top rim portion 14P so that when the container contains heavy objects (which is likely), and when the user tries to pull the container at the top rim portion 14P, the U-shaped top rim portion 14P is susceptible to the concentration of the pulling force and will break easily.

A user may mitigate this disadvantage by trying to apply pulling or carrying force at several points of the top rim portion 14P. While this may help in preventing breakage of the top rim portion 14P of the nursery container, in practice, the user may not be able to do so very frequently. For example, when the plant which is grown in the receiving cavity is very tall, the user may not be able to use both of his hands for grabbing two opposed portions of the top rim portions 14P of the container body 10P because the plaint may hit the body of the user, making him very difficult to move the container.

Second, the bottom panel 12P is usually a flat and simple panel for containing the soils and plants grown within the receiving cavity. Since the bottom panel 12P is also made of plastic material, when the objects contained in the receiving cavity are heavy, when the user lifts up the entire nursery container, the bottom panel 12P may break as a result because the support from the ground suddenly disappears. In fact, this frequently happens in conventional nursery containers such as the one described above.

Third, in some occasions, the nursery container would be lifted by some sorts of lifting devices. A selected lifting device is usually arranged to engage with the top rim portion 14P of the container. During the lifting process, the top rim portion 14P will break very easily because of the reasons mentioned above. Furthermore, even if the top rim portion 14P does not break, there is another problem: the engagement between the lifting device and the top rim portion 14P of the nursery container may not be secure enough so that the nursery container may slip with respective to the lifting device. The result is that

### SUMMARY OF THE PRESENT INVENTION

A main object of the present invention is to provide a nursery container comprising a grip-and-hold arrangement which is capable of minimizing stress concentration at a reinforcing rim thereof so as to allow easy moving of the nursery container without significant risk of breakage at the reinforcing rim.

Another object of the present invention is to provide a nursery container which comprises a grip-and-hold arrangement, wherein a sidewall and a bottom panel of the nursery container are specifically designed to sustain great loading without significant risk of breakage.

Another object of the present invention is to provide a nursery container comprising a grip-and-hold arrangement which allows easy and convenient lifting of the nursery container either manually or by a lifting device. When the nursery container is lifted by a lifting device, the grip-and-hold arrangement is arranged to engage with the lifting device to minimize slipping of the nursery container.

Another object of the present invention is to provide a nursery container which comprises a grip-and-hold arrangement, wherein the nursery container is manufactured by injection molding of plastic material. In other words, both the manufacturing cost as well as the risk of breakage of the nursery container of the present invention can be kept to the minimum.

Accordingly, in order to accomplish the above objects, the present invention provides a nursery container, comprising:

a container body which has at least one sidewall defining a nursery compartment within the container body, and a bottom panel, wherein the sidewall has a top edge portion; and

a grip-and-hold arrangement formed at the top edge portion of the sidewall of the container body, and comprises a reinforcing rim integrally and outwardly extended from the top edge portion of the sidewall, wherein the reinforcing rim has a curved sectional shape formed along an entire length of the reinforcing rim so as to evenly distribute externally applied force along the reinforcing rim without substantial stress concentration, wherein a user is allowed to effectively grip on the reinforcing rim to carry an entire structure of the nursery container without significant risk of breakage at the reinforcing rim.

These and other objectives, features, and advantages of the present invention will become apparent from the following detailed description, the accompanying drawings, and the appended claims.

### BRIEF DESCRIPTION OF THE DRAWINGS

FIG. 1 is section side view of a conventional nursery container.

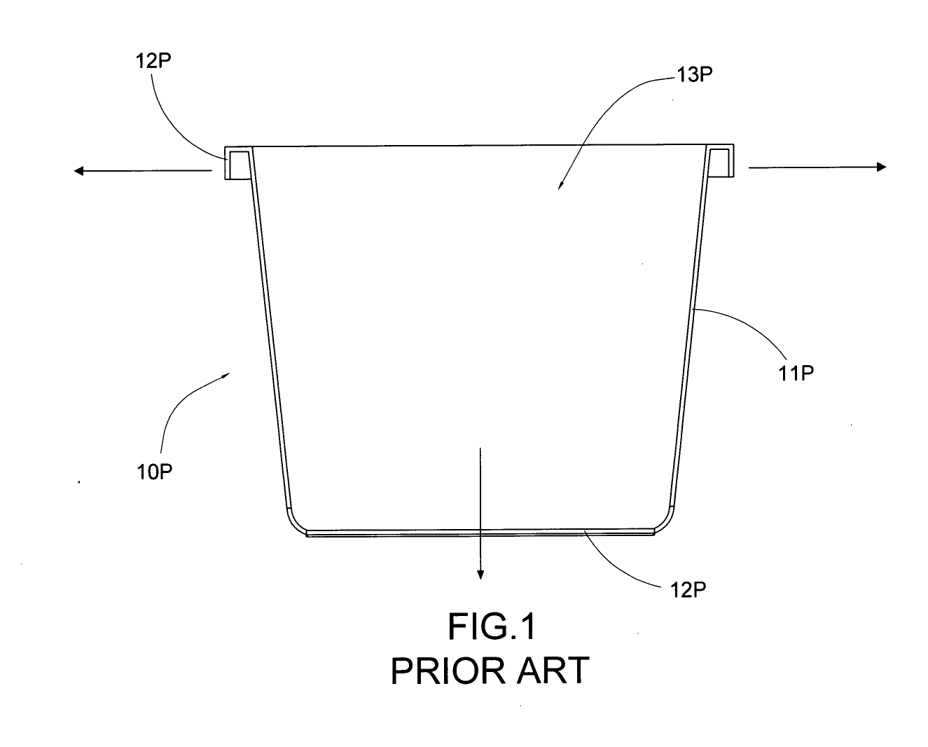

FIG. 2 is a perspective view of a nursery container according to a preferred embodiment of the present invention.

FIG. 3 is a sectional side view of the nursery container according to a preferred embodiment of the present invention.

FIG. 4 is a bottom perspective view of the nursery container according to a preferred embodiment of the present invention.

FIG. 5 is a schematic diagram of the nursery container according to a preferred embodiment of the present invention.

FIG. 6 is a enlarged schematic diagram illustrating a bottom portion of the nursery container according to a preferred embodiment of the present invention.

FIG. 7 is an alternative mode of the nursery container according to the above preferred embodiment of the present invention.

### DETAILED DESCRIPTION OF THE PREFERRED EMBODIMENT

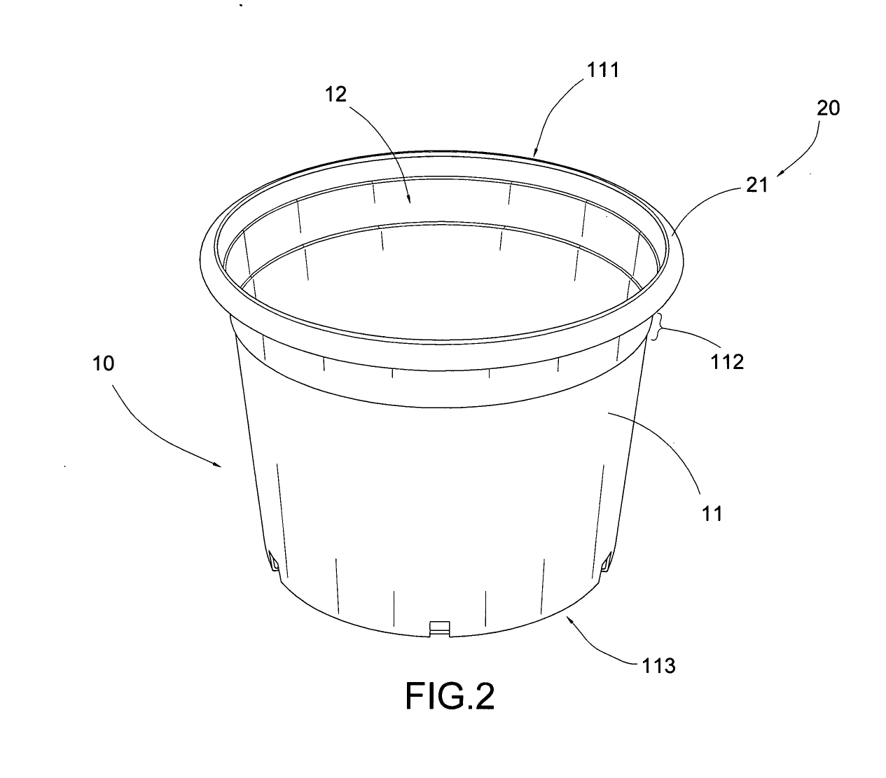

Referring to FIG. 2 to FIG. 6 of the drawings, a nursery container according to a preferred embodiment of the present invention is illustrated, in which the nursery container comprises a container body 10, and a grip-and-hold arrangement 20.

The container body 10 has at least one sidewall 11 defining a nursery compartment 12 within the container body 10, and a bottom panel 13. The sidewall 11 has a top edge portion 111.

On the other hand, the grip-and-hold arrangement 20 is formed at the top edge portion 111 of the sidewall 11 of the container body 10, and comprises a reinforcing rim 21 outwardly extended from the top edge portion 111 of the sidewall 11, wherein the reinforcing rim 21 has a curved sectional shape formed along an entire length of the reinforcing rim 21 so as to evenly distribute externally applied force along the reinforcing rim 21 without substantial stress concentration, wherein a user is allowed to effectively grip on the reinforcing rim 21 to carry an entire structure of the nursery container without significant risk of breakage at the reinforcing rim 21.

According to the preferred embodiment of the present invention, the container body 10 has one sidewall 11 for forming a substantially circular cross section of the container body 10. It must be pointed out, however, that the container body 10 may have different cross sectional shape wherein a corresponding number of sidewalls 11 may be used to form such a cross sectional shape. For example, the container body 10 may have a rectangular cross section having four sidewalls 11 integrally extended to form a correspondingly rectangular loop.

The sidewall 11 is upwardly extended from the bottom panel 13 so that the nursery compartment 12 is defined between the sidewall 11 and the bottom panel 13. The sidewall 11 may be vertically extended from the bottom panel or can have a slight inclination with the bottom panel 13.

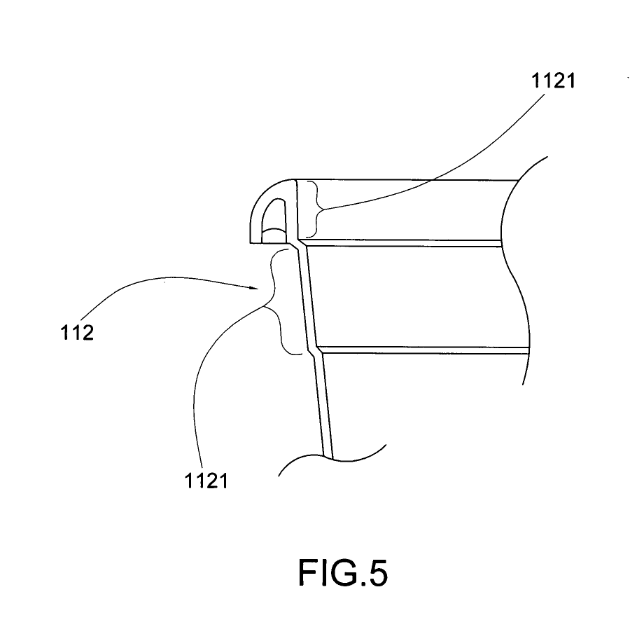

The reinforcing rim 21 is preferred to be integrally and outwardly extended from the top edge portion 111 of the sidewall 11 and has a corresponding cross sectional shape compatible with the cross sectional shape of the container body 10. In other words, the reinforcing rim 21 in this preferably to have a circular cross section which is compatible with the circular cross sectional shape of the container body 10. In order to enhance the strength of the reinforcing rim 21, at least an intersection portion between the reinforcing rim 21 and the top edge portion 111 of the sidewall 11 is thickened so that the relevant portion of the reinforcing rim 21 is capable of withstanding a greater amount of force without substantial risk of breakage. It is worth mentioning, however, that the entire reinforcing rim 21 can also be thickened as compared with the sidewall 11 for further enhancing the ability to withstand external pulling force. The term “thickened” as mentioned above refers to increase of thickness with respective to the sidewall 11 (as shown in FIG. 5 of the drawings).

The reinforcing rim 21 has a curved cross section shape and therefore defines a predetermined curvature to form a substantially hooked-shaped cross section of the reinforcing rim 21. The space created by curved cross sectional shape of the reinforcing rim 21 is defined as a reinforcing cavity 211. The predetermined curvature serves to distribute stress along the entire reinforcing rim 21 and therefore minimize stress concentration at any give point on the reinforcing rim 21. As a result, the risk of breakage at the reinforcing rim 21 can be minimized. Thus, the nursery container can be lifted up or moved from one place to another without having to subject to substantial risk of breakage at the reinforcing rim 21 (this is in stark contrast with the problems mentioned for conventional nursery container as described above).

It is important to mention that since the reinforcing rim 21 has a curved cross section, when the user lifts or pulls the nursery container manually, he or she may put his or her fingers in the reinforcing cavity 211 and exerts the necessary pulling or lifting force. Since there is no acute angle formed on the reinforcing rim 21, there is no substantial stress concentration and the pulling force will be evenly distributed along the entire reinforcing rim 21.

In order to further mitigate the problem of stress concentration, the intersection between the reinforcing rim 21 and the top edge portion 111 of the sidewall 11 is made curved at least on a top side of the reinforcing rim 21 for further avoiding concentration of stress caused by the externally applied pulling or lifting force.

In order to further enhance the strength of the reinforcing rim 21, the hold-and-grip arrangement 20 further comprises a plurality of reinforcing panels 22 spacedly provided in the reinforcing cavity 211. Each of the reinforcing panels 22 extends across the reinforcing cavity 211 to connect with the reinforcing rim 21 with the top edge portion 111 of the sidewall 11. In other words, each of the reinforcing panels 22 is integrally and inclinedly extended from the reinforcing aim 21 to connect with an outer surface of the sidewall 11 at the top edge portion 111 to form a triangular reinforcing structure for providing additional reinforcement to the reinforcing aim 21. The reinforcing panels 22, which are spacedly distributed along the entire reinforcing rim 21, are adapted for engaging with a lifting device so as to ensure secure engagement (without slipping) between the reinforcing rim 21 and the lifting device.

The sidewall 11 of the container body 10 further has a supporting portion 112 formed thereon for enhancing a structural strength of the sidewall 11. More specifically, the supporting portion 112 has a plurality of strengthening sections 1121 each of which is integrally extended from an adjacent strengthening section 1121 or the sidewall 11, wherein each strengthening section 1121 of the sidewall 11 has different cross sectional diameter with respective to an adjacent strengthening section 1121 so as to form a step-shouldering structure of the container body 10.

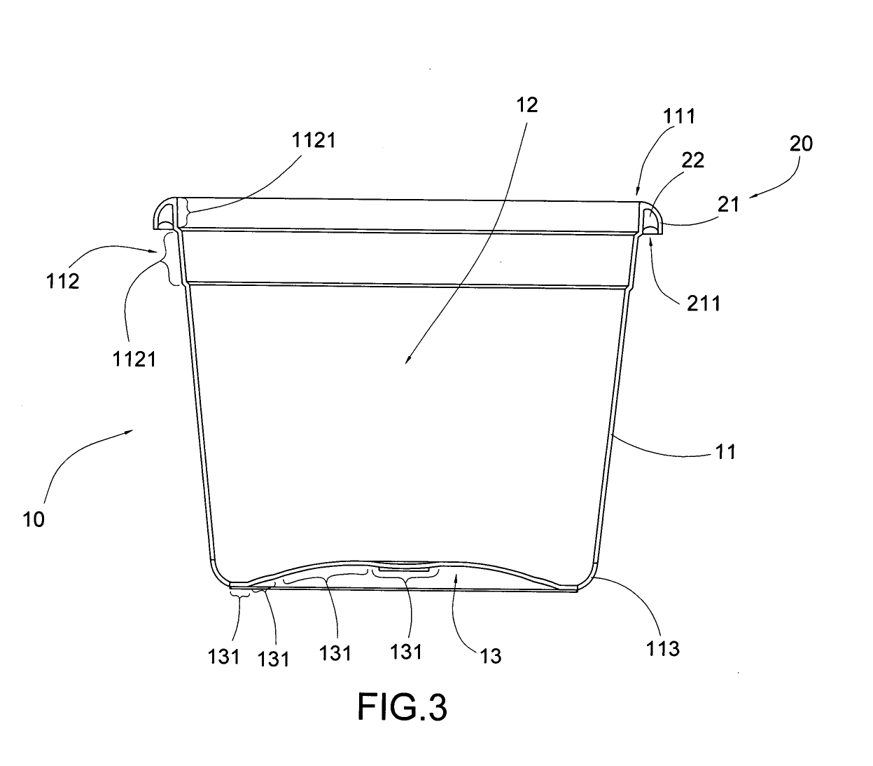

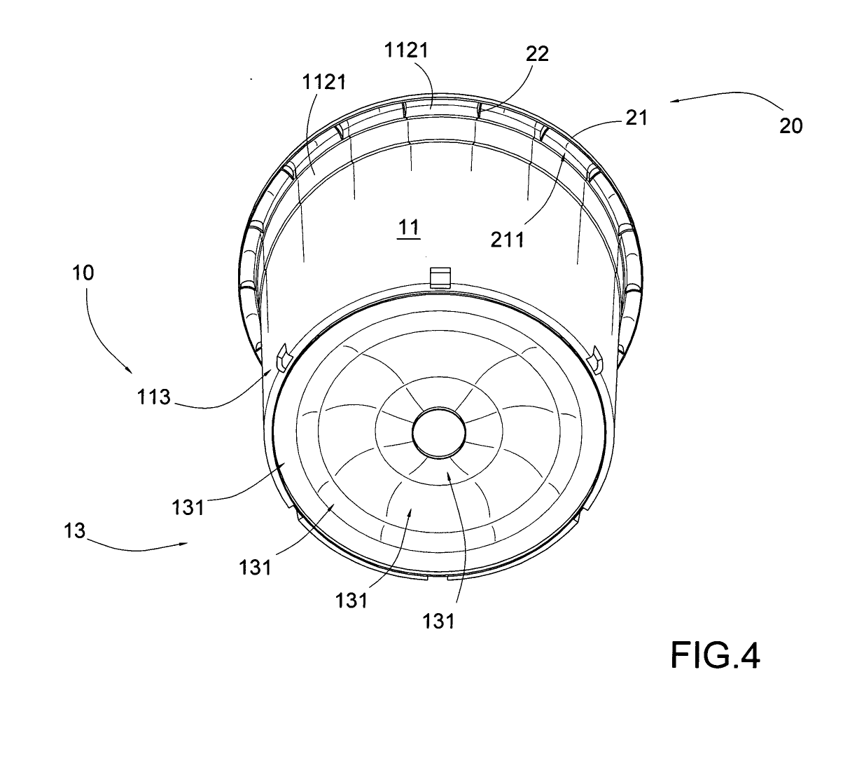

As shown in FIGS. 3 and 4 of the drawings, the bottom panel 13 of the container body 10 has a plurality of reinforcing sections 131, wherein each of the reinforcing sections 131 has an elevation altitude different from that of an adjacent reinforcing section 131 so as to form a generally concave cross section for the bottom panel 13. More specifically, each but the bottommost of the reinforcing sections 131 is circular in cross-sectional shape and is upwardly and inclinedly extended from an adjacent reinforcing section 131 having a lower elevation altitude so that each of the reinforcing sections 131 forms a predetermined angle of inclination with respect to a horizontal reference. For the outermost reinforcing section 131, it rests on the ground and therefore has a zero degree of angle of inclination with respect to the horizontal. The innermost reinforcing section 131, i.e. the center portion of the bottom panel 13, is curving downwardly and is a convex section of the bottom panel 13. The middle reinforcing section 131, i.e. the section between the outermost and innermost sections 131, is curving upwardly and is a concave section of the bottom panel 13. It is worth mentioning that the middle reinforcing section 131 contains two or more different ring-shaped sections with different inclination angles to further enhance the reinforcement of the bottom panel 13 when the weight of the object exerts thereat.

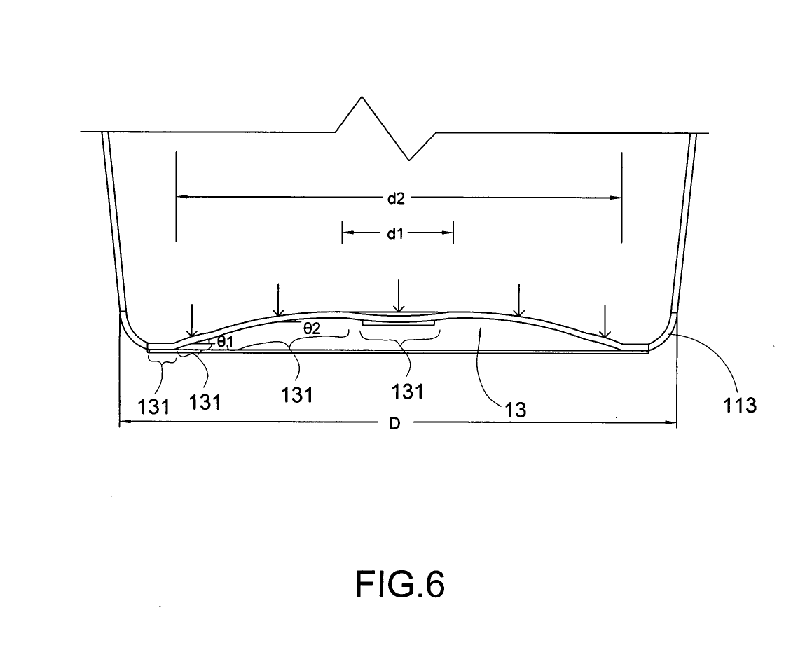

As shown in FIG. 6 of the drawings, each of the reinforcing sections 131 forms different angles of inclinations with respective to horizontal (such as θ₁ and θ₂), wherein a diameter of the respective reinforcing section 131 is also specifically designed to have a predetermined ratio. For example, as shown in FIG. 6, the diameter d₁ is preferably to be 20% of the diameter of D, the diameter of the bottom panel 13 of the nursery diameter. Moreover the diameter d₂ is preferably to be 80% of diameter D.

It is worth mentioning that the nursery container of the present invention is preferably manufactured by injection holding so that all of the components described above form an integral structure. Alternatively, the present invention also contemplates different manufacturing methods so that the components described above do not necessarily form an integral structure. Notwithstanding different manufacturing methods, the core patentable subject matter of the present invention remains the same.

The container body 11 further has a plurality of drainage holes 113 spacedly provided along an intersection between the sidewall 11 and the bottom panel 13 for allowing water to drain out of the nursery compartment 12 via those drainage holes 113.

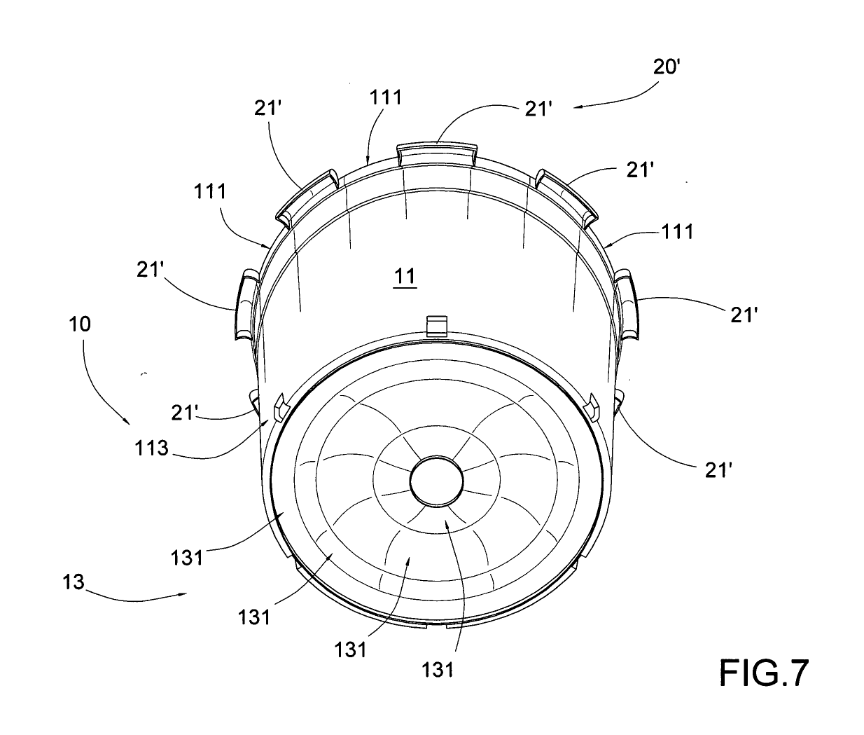

Referring to FIG. 7 of the drawings, an alternative mode of the nursery container according to the preferred embodiment of the present invention is illustrated, in which the alternative mode is similar to the preferred embodiment, except the grip-and-hold arrangement 20′. According to the alternative mode, the grip-and-hold arrangement 20′ comprises a plurality of discrete reinforcing rim 21′ as described above so as to allow users to grip thereon for lifting up the nursery container.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A nursery container, comprising:
a container body which has at least one sidewall defining a nursery compartment within said container body, and a bottom panel, wherein said sidewall has a top edge portion; and
a grip-and-hold arrangement formed at said top edge portion of said sidewall of said container body, and comprises a reinforcing rim integrally and outwardly extended from said top edge portion of said sidewall, wherein said reinforcing rim has a curved sectional shape formed along an entire length of said reinforcing rim so as to evenly distribute externally applied force along said reinforcing rim without substantial stress concentration, wherein said container body is allowed to be effectively gripped at said reinforcing rim to carry an entire structure of said nursery container without significant risk of breakage at said reinforcing rim.

2. The nursery container, as recited in claim 1, wherein said container body has one sidewall for forming a substantially circular cross section of said container body, wherein said sidewall is upwardly extended from said bottom panel so that said nursery compartment is defined between said sidewall and said bottom panel.

3. The nursery container, as recited in claim 2, wherein said reinforcing rim is integrally and outwardly extended from said top edge portion of said sidewall and has a corresponding cross sectional shape compatible with said cross sectional shape of said container body.

4. The nursery container, as recited in claim 3, wherein at least an intersection portion of said reinforcing rim and said top edge portion of said sidewall is thickened so that said intersection portion of said reinforcing rim is capable of withstanding a greater amount of force without substantial risk of breakage.

5. The nursery container, as recited in claim 3, wherein said reinforcing rim has a curved cross section shape and therefore defines a predetermined curvature to form a substantially hooked-shaped cross section of said reinforcing rim, wherein a space created by curved cross sectional shape of said reinforcing rim is defined as a reinforcing cavity, wherein said predetermined curvature serves to distribute stress along said entire reinforcing rim and minimize stress concentration at any give point on said reinforcing rim.

6. The nursery container, as recited in claim 4, wherein said reinforcing rim has a curved cross section shape and therefore defines a predetermined curvature to form a substantially hooked-shaped cross section of said reinforcing rim, wherein a space created by curved cross sectional shape of said reinforcing rim is defined as a reinforcing cavity, wherein said predetermined curvature serves to distribute stress along said entire reinforcing rim and minimize stress concentration at any give point on said reinforcing rim.

7. The nursery container, as recited in claim 5, wherein said intersection between said reinforcing rim and said top edge portion of said sidewall is made curved at least on a top side of said reinforcing rim for further avoiding concentration of stress caused by said externally applied pulling or lifting force.

8. The nursery container, as recited in claim 6, wherein said intersection between said reinforcing rim and said top edge portion of said sidewall is made curved at least on a top side of said reinforcing rim for further avoiding concentration of stress caused by said externally applied pulling or lifting force.

9. The nursery container, as recited in claim 4, wherein said hold-and-grip arrangement further comprises a plurality of reinforcing panels spacedly provided in said reinforcing cavity, wherein each of said reinforcing panels extends across said reinforcing cavity to connect with said reinforcing rim with said top edge portion of said sidewall, such that each of said reinforcing panels is integrally and inclinedly extended from said reinforcing aim to connect with an outer surface of said sidewall at said top edge portion to form a triangular reinforcing structure for providing additional reinforcement to said reinforcing aim, wherein said reinforcing panels are adapted for engaging with a lifting device so as to ensure secure engagement between said reinforcing rim and said lifting device.

10. The nursery container, as recited in claim 6, wherein said hold-and-grip arrangement further comprises a plurality of reinforcing panels spacedly provided in said reinforcing cavity, wherein each of said reinforcing panels extends across said reinforcing cavity to connect with said reinforcing rim with said top edge portion of said sidewall, such that each of said reinforcing panels is integrally and inclinedly extended from said reinforcing aim to connect with an outer surface of said sidewall at said top edge portion to form a triangular reinforcing structure for providing additional reinforcement to said reinforcing aim, wherein said reinforcing panels are adapted for engaging with a lifting device so as to ensure secure engagement between said reinforcing rim and said lifting device.

11. The nursery container, as recited in claim 8, wherein said hold-and-grip arrangement further comprises a plurality of reinforcing panels spacedly provided in said reinforcing cavity, wherein each of said reinforcing panels extends across said reinforcing cavity to connect with said reinforcing rim with said top edge portion of said sidewall, such that each of said reinforcing panels is integrally and inclinedly extended from said reinforcing aim to connect with an outer surface of said sidewall at said top edge portion to form a triangular reinforcing structure for providing additional reinforcement to said reinforcing aim, wherein said reinforcing panels are adapted for engaging with a lifting device so as to ensure secure engagement between said reinforcing rim and said lifting device.

12. The nursery container, as recited in claim 6, wherein said sidewall of said container body further has a supporting portion formed thereon for enhancing a structural strength of said sidewall, wherein said supporting portion has a plurality of strengthening sections each of which is integrally extended from an adjacent strengthening section or said sidewall, wherein each strengthening section of said sidewall has different cross sectional diameter with respective to an adjacent strengthening section.

13. The nursery container, as recited in claim 8, wherein said sidewall of said container body further has a supporting portion formed thereon for enhancing a structural strength of said sidewall, wherein said supporting portion has a plurality of strengthening sections each of which is integrally extended from an adjacent strengthening section or said sidewall, wherein each strengthening section of said sidewall has different cross sectional diameter with respective to an adjacent strengthening section.

14. The nursery container, as recited in claim 11, wherein said sidewall of said container body further has a supporting portion formed thereon for enhancing a structural strength of said sidewall, wherein said supporting portion has a plurality of strengthening sections each of which is integrally extended from an adjacent strengthening section or said sidewall, wherein each strengthening section of said sidewall has different cross sectional diameter with respective to an adjacent strengthening section.

15. The nursery container, as recited in claim 8, wherein said bottom panel of said container body has a plurality of reinforcing sections, wherein each of said reinforcing sections has an elevation altitude different from that of an adjacent reinforcing section so as to form a generally concave cross section for said bottom panel, wherein each but said bottommost of said reinforcing sections is circular in cross-sectional shape and is upwardly and inclinedly extended from an adjacent reinforcing section having a lower elevation altitude so that each of said reinforcing sections forms a predetermined angle of inclination with respect to a horizontal reference.

16. The nursery container, as recited in claim 11, wherein said bottom panel of said container body has a plurality of reinforcing sections, wherein each of said reinforcing sections has an elevation altitude different from that of an adjacent reinforcing section so as to form a generally concave cross section for said bottom panel, wherein each but said bottommost of said reinforcing sections is circular in cross-sectional shape and is upwardly and inclinedly extended from an adjacent reinforcing section having a lower elevation altitude so that each of said reinforcing sections forms a predetermined angle of inclination with respect to a horizontal reference.

17. The nursery container, as recited in claim 14, wherein said bottom panel of said container body has a plurality of reinforcing sections, wherein each of said reinforcing sections has an elevation altitude different from that of an adjacent reinforcing section so as to form a generally concave cross section for said bottom panel, wherein each but said bottommost of said reinforcing sections is circular in cross-sectional shape and is upwardly and inclinedly extended from an adjacent reinforcing section having a lower elevation altitude so that each of said reinforcing sections forms a predetermined angle of inclination with respect to a horizontal reference.

18. The nursery container, as recited in claim 11, wherein said grip-and-hold arrangement comprises a plurality of discrete reinforcing rims spacedly formed on said container body for enhancing a strength of said nursery container.

19. The nursery container, as recited in claim 14, wherein said grip-and-hold arrangement comprises a plurality of discrete reinforcing rims spacedly formed on said container body for enhancing a strength of said nursery container.

20. The nursery container, as recited in claim 17, wherein said grip-and-hold arrangement comprises a plurality of discrete reinforcing rims spacedly formed on said container body for enhancing a strength of said nursery container.
